(19) United States
(12) Patent Application Publication
(10) Pub. No.: US 2022/0164784 A1
(43) Pub. Date: May 26, 2022

(54) MOBILE PAYMENT DEVICE AND METHOD OF OPERATION OF THE SAME

(71) Applicant: BEAUTIFUL CARD CORPORATION, Taoyuan City (TW)

(72) Inventor: MENG-JEN CHENG, Taoyuan City (TW)

(21) Appl. No.: 17/100,971

(22) Filed: Nov. 23, 2020

(51) Int. Cl. G06Q 20/32; G06Q 20/34; G06K 7/10; G06Q 20/40; G06Q 40/02

(52) U.S. Cl. CPC G06Q 20/3227; G06Q 20/341; G06Q 20/352; G06Q 20/40145; G06K 7/10316; G06Q 20/4018; G06Q 40/02; G06K 7/10415

(57) ABSTRACT

A mobile payment device includes a central control unit, an identity authentication module, an input interface, a display module, a security chip, an induction antenna and a cuboid casing. The central control unit is electrically connected to the identity authentication module, the input interface, the display module, and the security chip. The central control unit selects, according to an input signal inputted by a holder of the mobile payment device, one of at least one card information displayed on the display module to allow the selected card information to serve as payment card information and starts the security chip according to a signal inputted by the holder before making payment, thereby allowing the security chip to provide the payment card information to the induction antenna.

### BACKGROUND OF THE INVENTION

### 1. Field of the Invention

The present disclosure relates to mobile payment devices and methods of operation of the same, and in particular to a mobile payment device for offline payment and a method of operation of the mobile payment device.

### 2. Description of the Related Art

In general, sales promotions vary from retailer to retailer, depending on the retailers' marketing strategies. Common marketing strategies include member concessions and credit card concessions. As a result, each consumer often holds several credit cards in order to be entitled to greatest possible concessions.

To gain access to greatest possible concessions, each consumer carries several credit cards which take up much space in his/her wallet and are difficult to manage simultaneously. Therefore, the prior art still has room for improvement.

### BRIEF SUMMARY OF THE INVENTION

An objective of the present disclosure is to provide a mobile payment device and a method of operation of the same to manage a plurality of card information with one single mobile payment device. The mobile payment device does not take up much space but is conducive to offline transactions. Furthermore, the mobile payment device and the method of operation of the same provide a security authentication mechanism accepted by international credit card institutions, so as to enhance the ease and security of using the mobile payment device.

To achieve at least the above objective, the present disclosure provides a method of operation of a mobile payment device. The method comprises the steps of: confirming, after an identity authentication, a payment card information; and receiving, before a payment, an enabling signal for starting a security chip and instructing the security chip to provide the payment card information for a transaction.

Therefore, upon completion of the identity authentication, the mobile payment device further confirms the payment card information for use in making payment. Then, prior to payment, the mobile payment device starts the security chip to carry out a transaction. Therefore, the holder of the mobile payment device only needs to carry one single mobile payment device in order to carry a plurality of payment card information and uses the mobile payment device to select the intended payment card information. The holder can access the mobile payment device, only after the holder's identity has been authenticated. The holder does not need to carry multiple cards in order to make payment with the mobile payment device safely and power-efficiently, thereby enhancing the ease and security of using the mobile payment device.

To achieve at least the above objective, the present disclosure further provides a mobile payment device, comprising a central control unit, an identity authentication module, an input interface, a display module, a security chip, an induction antenna and a cuboid casing, wherein the central control unit is electrically connected to the identity authentication module, the input interface, the display module, and the security chip. The central control unit selects, according to an input signal inputted by a holder of the mobile payment device, one of at least one card information displayed on the display module to allow the selected card information to serve as payment card information and starts the security chip according to an enabling signal received, thereby allowing the security chip to provide the payment card information to the induction antenna.

Therefore, upon completion of the identity authentication, the mobile payment device further confirms the payment card information for use in making payment. Then, prior to payment, the mobile payment device starts the security chip to carry out a transaction. Therefore, the holder of the mobile payment device only need to carry one single mobile payment device in order to select multiple payment card information, such that the mobile payment device selects the desirable payment card information without requiring the holder to carry multiple physical cards, so as to make payment safely and power efficiently and enhance the ease and security of using the mobile payment device.

### BRIEF DESCRIPTION OF THE DRAWINGS

FIG. 1 is a block diagram of a mobile payment device according to an embodiment of the present disclosure.

FIG. 2 is a top view of the mobile payment device according to an embodiment of the present disclosure.

FIG. 3 is a perspective view of the mobile payment device according to an embodiment of the present disclosure.

FIG. 4 is a top view of a mobile payment device according to another embodiment of the present disclosure.

FIG. 5 is a flowchart of a method of operation of a mobile payment device according to an embodiment of the present disclosure.

FIG. 6 is another flowchart of a method of operation of a mobile payment device according to an embodiment of the present disclosure.

FIG. 7 is yet another flowchart of a method of operation of a mobile payment device according to an embodiment of the present disclosure.

FIG. 8 is still yet another flowchart of a method of operation of a mobile payment device according to an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

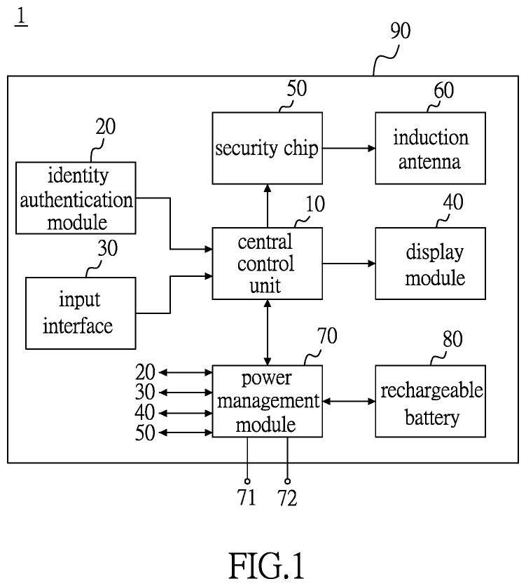

Referring to FIG. 1, there is shown a block diagram of a mobile payment device 1 according to an embodiment of the present disclosure. The mobile payment device 1 comprises a central control unit 10, an identity authentication module 20, an input interface 30, a display module 40, a security chip 50, an induction antenna 60, a power management module 70 and a rechargeable battery 80. The central control unit 10 is electrically connected to the identity authentication module 20, the input interface 30, the display module 40, and the security chip 50.

The identity authentication module 20 receives an identity information of a holder of the mobile payment device 1 to perform an identity authentication. Specifically speaking, the identity authentication module 20 receives the identity information of the holder of the mobile payment device 1 and then determines whether the identity information matches one of identity authentication information built in the identity authentication module 20 so as to generate an authenticated information and an unauthenticated information accordingly. The authenticated information indicates that the identity information matches one of the identity authentication information built in the identity authentication module 20. The unauthenticated information indicates that the identity information matches none of the identity authentication information built in the identity authentication module 20.

The input interface 30 generates an input signal according to the holder's operation. In this embodiment, the input signal controls display frames of the display module 40, is used to select at least one card information for use as payment card information, and serves as a start signal for starting the security chip 50.

The display module 40 displays the at least one card information according to the input signal.

The security chip 50 encrypts and provides the selected payment card information to the induction antenna 60.

The induction antenna 60 is electrically connected to the security chip 50 to receive and send the payment card information to a corresponding external induction antenna (not shown).

Upon completion of the identity authentication, the central control unit 10 instructs the display module 40 to display the at least one card information, selects, according to an input signal inputted by a holder of the mobile payment device, one of at least one card information displayed on the display module to allow the selected card information to serve as payment card information and starts the security chip according to a start signal inputted by the holder before making payment, thereby allowing the security chip to provide the payment card information to the induction antenna.

A power management module 70 is electrically connected to the central control unit 10, the identity authentication module 20, the input interface 30, the display module 40, the security chip 50, and the rechargeable battery 80 to control the rechargeable battery 80 and thereby supply electric power required for operation of the central control unit 10, the identity authentication module 20, the input interface 30, the display module 40, the security chip 50, and the induction antenna 60. The power management module 70 stores received electric power in the rechargeable battery 80. The power management module 70 further comprises a first end 71 and a second end 72. The first end 71 and the second end 72 are in contact with and electrically connected to a charging device whereby the rechargeable battery 80 is recharged.

The central control unit 10 operates in a wireless communication mode in which the central control unit 10 is in communicative connection with an external electronic device (for example, a smartphone or a tablet) to receive the at least one card information for use as the payment card information.

The mobile payment device 1 further comprises a cuboid casing 90 for containing the central control unit 10, the identity authentication module 20, the input interface 30, the display module 40, the security chip 50, the induction antenna 60, the power management module 70 and the rechargeable battery 80.

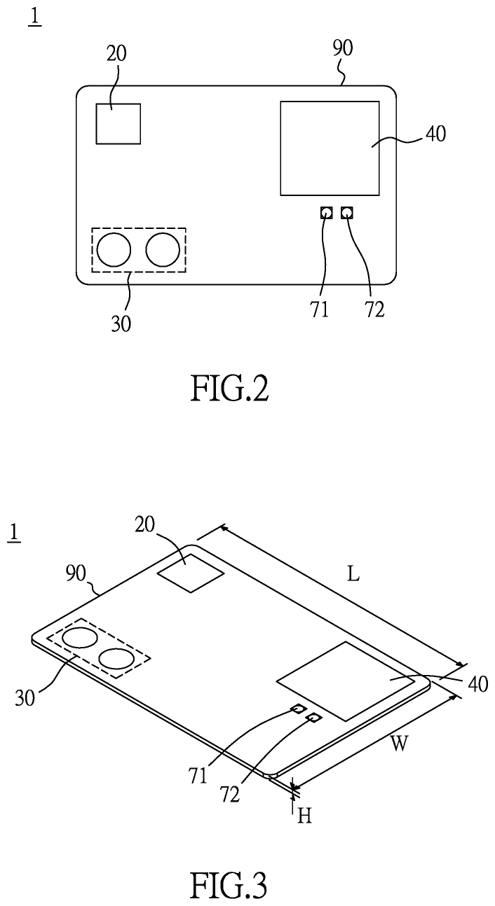

Referring to FIG. 2, there is shown a top view of the mobile payment device according to an embodiment of the present disclosure. As shown in FIG. 2, the identity authentication module 20, the input interface 30, the display module 40, the first end 71 and the second end 72 are exposed from the cuboid casing 90.

The holder holding the mobile payment device 1 undergoes the identity authentication with the identity authentication module 20, operates the input interface 30 with the card information displayed on the display module 40 to select the card information for use as the payment card information, and operates the input interface 30 to generate a start signal for starting the security chip 50, so as to make payment.

In this embodiment, the first end 71 is a ground (GND) charging end, and the second end 72 is a power (VCC) charging end. Thus, the power charging end is positioned proximate to the edge of the cuboid casing 90, whereas the ground charging end is positioned distal to the edge of the cuboid casing 90 relative to the power charging end. Referring to FIG. 2 through FIG. 4, when the mobile payment device 1 is in contact and connection with the charging device, the second end 72 is a power (VCC) charging end, such that the power end of the charging device cannot come into contact with the ground charging end of the mobile payment device 1 to create a short circuit, thereby protecting the charging device and/or the mobile payment device 1 against damage and promoting the security of using the mobile payment device 1.

In this embodiment, the at least one card information is a code generated by a credit card digitalization mechanism provided by a credit card issuing institution. Therefore, payment can be made by the mobile payment device 1 with the code in the absence of any connection to the Internet, thereby achieving the function of physical credit card payment.

In an embodiment, the central control unit 10 is, for example, a Bluetooth chip module, but the present disclosure is not limited thereto.

In an embodiment, the identity authentication module 20 is, for example, a fingerprint recognition module, and the identity information is the holder's fingerprint, but the present disclosure is not limited thereto.

In an embodiment, the input interface 30 is, for example, a touch switch or touch control panel, but the present disclosure is not limited thereto.

In an embodiment, the display module 40 is, for example, an e-paper module, but the present disclosure is not limited thereto.

In an embodiment, the dimensions (i.e., length and width) of the cuboid casing 90 comply with ISO/IEC7810-ID1.

Referring to FIG. 3, there is shown a perspective view of the mobile payment device according to an embodiment of the present disclosure. As shown in FIG. 3, the cuboid casing 90 of the mobile payment device 1 has a length L, a width W and a height H. In this embodiment, the length L ranges from 85.1 mm to 86.1 mm, and the length L is preferably equal to 85.6 mm. In this embodiment, the width W ranges from 53.48 mm to 54.48 mm, and the width W is preferably equal to 53.98 mm. In this embodiment, the height H ranges from 0.75 mm to 1.5 mm, and the height H is preferably equal to 0.80 mm. Therefore, the dimensions of the mobile payment device 1 comply with ISO/IEC7810-ID1.

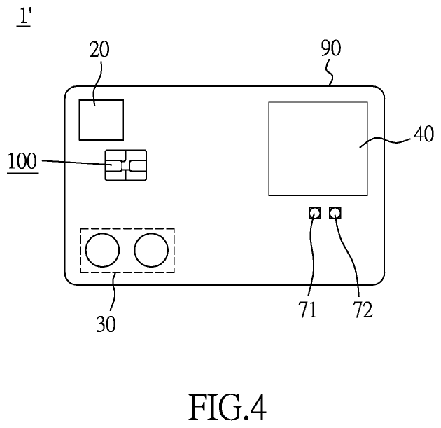

Referring to FIG. 4, there is shown a top view of a mobile payment device 1′ according to another embodiment of the present disclosure. As shown in FIG. 4, the mobile payment device 1′ further comprises a contact-style smart card chip module 100. Therefore, the mobile payment device 1′ is applicable to the cards of the contact-style smart card chip module 100, thereby broadening the application of the mobile payment device 1′.

In the embodiment illustrated by FIG. 4, the height H of the cuboid casing 90 ranges from 0.76 mm to 0.84 mm.

In an embodiment, the mobile payment device 1 or the mobile payment device 1′ is a card-shaped mobile payment device.

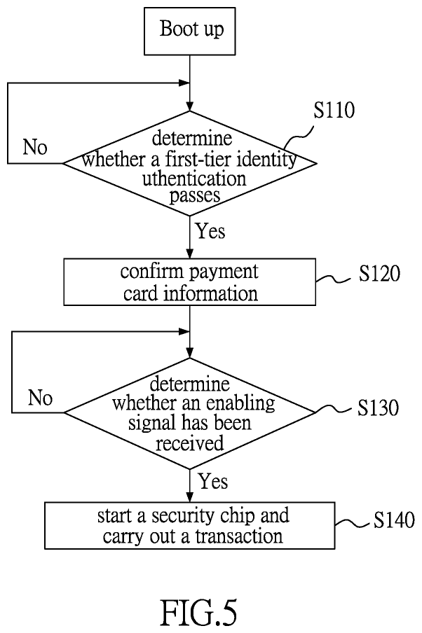

The present disclosure further provides a method of operation of a mobile payment device 1. Referring to FIG. 5, the method comprises the steps described below.

Step S110: determine whether a first-tier identity authentication passes.

The identity authentication module 20 of the mobile payment device 1 receives an identity information of the holder of the mobile payment device 1 to perform an identity authentication. If it is determined that the authentication passes, step S120 will take place; otherwise, the method will proceed to step S110.

Step S120: confirm payment card information. The central control unit 10 instructs a display module 40 to display at least one card information, selects one of the at least one card information displayed on the display module according to an input signal inputted by the holder, and uses the selected card information as the payment card information.

Step S130: determine whether an enabling signal has been received. The central control unit 10 determines whether an enabling signal inputted by the holder has been received. If the determination is affirmative, the method will proceed to step S140; otherwise, step S130 will be carried out again.

Step S140: start a security chip and carry out a transaction. The central control unit 10 starts the security chip according to the input signal, such that the security chip sends the payment card information to the induction antenna 60, thereby allowing the induction antenna 60 to send the payment card information to a corresponding external induction antenna in order to make payment. Thus, the security chip will be started, only if the central control unit 10 receives an input signal serving as the start signal. Therefore, the method is effective in reducing consumption of electric power and thus saving power.

Therefore, the holder of the mobile payment device 1 only needs to carry one single mobile payment device in order to carry a plurality of payment card information and uses the mobile payment device 1 to select the intended payment card information. The holder can access the mobile payment device 1, only after the holder's identity has been authenticated. The holder does not need to carry multiple cards in order to make payment with the mobile payment device safely and power-efficiently, thereby enhancing the ease and security of using the mobile payment device.

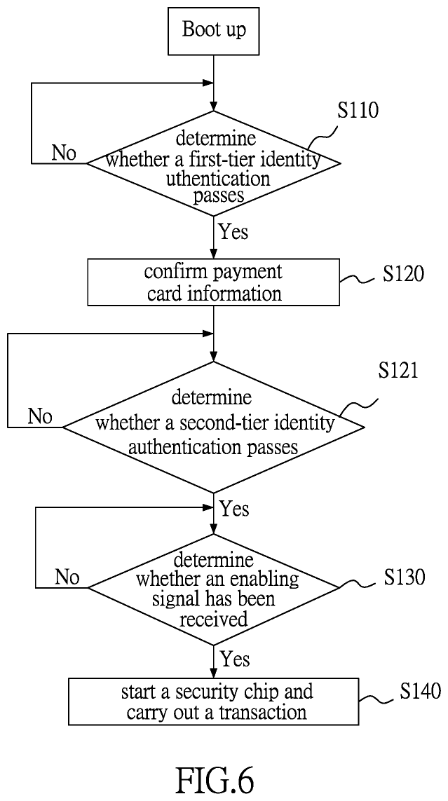

In an embodiment illustrated by FIG. 6, step S121, which follows step S120 but precedes step S130, involves determining whether an identity authentication passes. Again, the identity authentication module 20 receives the identity information inputted by the holder to perform a second-tier identity authentication. If the authentication passes, the method will proceed to step S130; otherwise, step S121 will be carried out again. Therefore, prior to the payment, the holder undergoes identity authentication once again to effectively enhance the security of using the mobile payment device.

In an embodiment, step S110 is preceded by step S100 which involves creating identity authentication information. Referring to FIG. 7, step S100 further comprises the steps below.

Step S101: start the mobile payment device 1.

Step S102: sense identity information. The holder enters the identity information to the identity authentication module 20.

Step S103: create identity authentication information. The identity authentication module 20 creates the identity authentication information according to the identity information which the holder inputs in step S102.

Therefore, the holder undergoes the identity authentication with the mobile payment device 1 according to the created identity authentication information.

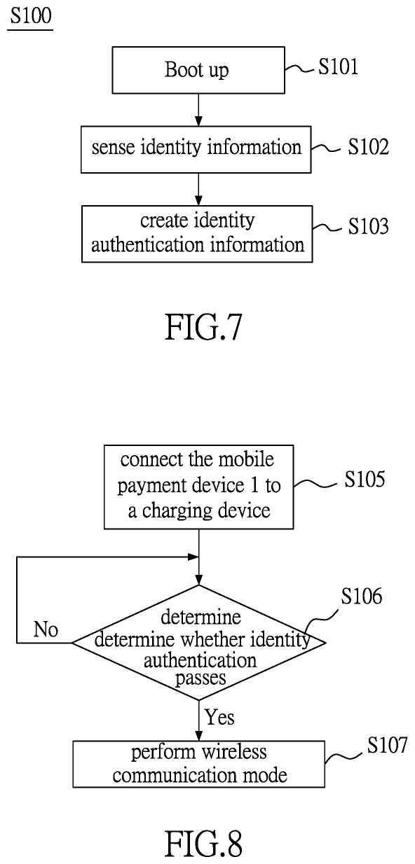

In an embodiment illustrated by FIG. 8, steps S105˜S107, which precede step S110 but follow step S100, are described below.

Step S105: connect the mobile payment device 1 to a charging device to perform charging. Step S105 triggers the execution of steps S106˜S107 on the mobile payment device 1.

Step S106: determine whether identity authentication passes. The identity authentication module 20 receives the identity information inputted by the holder to perform the identity authentication. If it is determined that the authentication passes, the method will proceed to step S107; otherwise, step S106 will be carried out again.

Step S107: perform wireless communication mode. The central control unit 10 connects to an external electronic device communication by wireless communication to receive at least one card information from the external electronic device.

Therefore, the external electronic device stores the at least one card information in the mobile payment device 1.

The mobile payment device 1 stores a plurality of card information to allow the holder of the mobile payment device 1 to make payment according to the card information stored in the mobile payment device 1 without carrying multiple cards. The mobile payment device 1 need not immediately come into communication and connection with a credit card center, thereby effectively simplifying the circuit design of the mobile payment device 1 and reducing the required cost. Furthermore, the present disclosure complies with authentication procedures and secure transaction mechanisms stipulated by international credit card institutions. In addition, the present disclosure ensures transaction security, reduces the probability of identity theft, and enhances the security of making payment with the mobile payment device 1. Moreover, the security chip is started just before payment to not only effectively reduce consumption of electric power but also enable the mobile payment device 1 to work without any large power device. Last but not least, the mobile payment device 1 is of minimal volume and weight to effectively enhance the ease of use of the mobile payment device 1.

While the present disclosure has been described by means of specific embodiments, numerous modifications and variations could be made thereto by those skilled in the art without departing from the scope and spirit of the present disclosure set forth in the claims.

What is claimed is:

1. A method of operation of a mobile payment device, comprising the steps of:
confirming, after an identity authentication, a payment card information; and
receiving, before a payment, an enabling signal for starting a security chip and instructing the security chip to provide the payment card information for a transaction.

2. The method of claim 1, further comprising:
sensing an identity information; and
creating an identity authentication information according to the identity information.

3. The method of claim 1, further comprising performing, upon connection to a charging device and after an identity authentication, wireless communication mode to receive at least one card information for use as the payment card information.

4. The method of claim 1, wherein the mobile payment device has a length of 85.1 mm—86.1 mm, a width of 53.48 mm˜54.48 mm, and a height of 0.75 mm˜1.5 mm.

5. A mobile payment device, comprising:
a central control unit;
an identity authentication module electrically connected to the central control unit to receive an identity information of a holder so as to perform an identity authentication;
an input interface electrically connected to the central control unit to generate an input signal;
a display module electrically connected to the central control unit to display at least one card information;
a security chip electrically connected to the central control unit to provide a payment card information;
an induction antenna electrically connected to the security chip to receive and send the payment card information; and
a cuboid casing for containing the central control unit, the identity authentication module, the input interface, the display module, the security chip and the induction antenna,
wherein the central control unit selects, according to the input signal inputted, one of the at least one card information displayed on the display module, uses the selected card information as the payment card information, and starts the security chip according to a received enabling signal before making payment, thereby allowing the security chip to provide the payment card information to the induction antenna.

6. The mobile payment device of claim 5, wherein the at least one card information is a code generated by a credit card digitalization mechanism provided by a credit card issuing institution.

7. The mobile payment device of claim 5, wherein the cuboid casing has a length of 85.1 mm˜86.1 mm, a width of 53.48 mm˜54.48 mm, and a height of 0.75 mm˜1.5 mm.

8. The mobile payment device of claim 5, wherein the mobile payment device further comprises a power management module and a rechargeable battery, and the power management module is electrically connected to the central control unit, the identity authentication module, the input interface, the display module, the security chip, and the rechargeable battery.

9. The mobile payment device of claim 8, wherein the power management module comprises a ground charging end and a power charging end, with the power charging end positioned proximate to an edge of the cuboid casing, and the ground charging end positioned distal to the edge of the cuboid casing relative to the power charging end.

10. The mobile payment device of claim 5, wherein the mobile payment device further comprises a contact-style smart card chip module.

11. The mobile payment device of claim 5, wherein the identity authentication module is a fingerprint recognition module.
